(19) United States
(12) Patent Application Publication
(10) Pub. No.: US 2010/0188614 A1
(43) Pub. Date: Jul. 29, 2010

(54) DRIVING APPARATUS AND METHOD FOR FLUORESCENT LAMP

(75) Inventors: Kenichi Fukumoto, Kyoto (JP); Yasuhiro Yamada, Kyoto (JP)

Correspondence Address: CANTOR COLBURN, LLP, 20 Church Street, 22nd Floor, Hartford, CT, 06103, US

(73) Assignee: ROHM CO., LTD., Kyoto (JP)

(21) Appl. No.: 12/665,835

(22) PCT Filed: Jun. 18, 2008
(86) PCT No.: PCT/JP2008/001571

§ 371 Date: Dec. 21, 2009

(30) Foreign Application Priority Data
Jun. 20, 2007 (JP) 2007-163169

(51) Int. Cl. G02F 1/1335; H05B 41/36

(52) U.S. Cl. 349/70; 315/250

(57) ABSTRACT

A driving apparatus includes an inverter to supply an AC voltage to Cold Cathode Fluorescent Lamps (CCFLs) to be driven. A first detection signal generation unit generates a first detection signal occurring by driving a first CCFL with the AC voltage. A second detection signal generation unit generates a second detection signal occurring by driving a second CCFL with the AC voltage. An abnormality detection circuit generates an abnormality detection signal corresponding to a difference between amplitudes of the first detection signal and the second detection signal. The driving apparatus compares the abnormality detection signal with a predetermined threshold value to execute a circuit protecting operation in accordance with a comparison result.

### BACKGROUND OF THE INVENTION

1. Field of the Invention

The present invention relates to a driving apparatus for a fluorescent lamp, and in particular, to a circuit protecting technique thereof.

2. Description of the Related Art

In recent years, Liquid Crystal Display (LCD) TVs, which are capable of being thin and large in size, have become popular instead of Cathode-Ray Tube (CRT) TVs. In the LCD TVs, a plurality of Cold Cathode Fluorescent Lamps (hereinafter, referred to as CCFLs) are arranged on the back surface of an LCD panel on which screen images are displayed, so that the CCFLs emit lights as backlights.

In order to drive the CCFL, an inverter (DC/AC converter) that outputs an AC voltage by boosting a DC voltage of, for example, approximately 12 V, is used. The inverter converts a current flowing in the CCFL into a voltage to apply the voltage to a control circuit as a feedback voltage, and controls on/off of a switching element based on the feedback voltage. For example, Patent Document 1 discloses a technique for driving the CCFL by using such an inverter.

[Patent Document 1] Japanese Patent Application Publication No. 2003-323994

For such a drive circuit, it is needed that an abnormal state in which the CCFL undergoes a fault or a poor connection occurs therein is detected such that a circuit protecting operation is executed if necessary.

### SUMMARY OF THE INVENTION

The present invention has been made in view of these circumstances, and a purpose thereof is to provide a fluorescent lamp drive circuit in which an abnormality can be detected.

An embodiment of the present invention relates to a driving apparatus that drives a plurality of fluorescent lamps. The driving apparatus comprises: an inverter that supplies an AC voltage to the plurality of fluorescent lamps to be driven; a first detection signal generation unit that generates a first detection signal corresponding to a first electric signal occurring by driving a first fluorescent lamp with the AC voltage; a second detection signal generation unit that generates a second detection signal corresponding to a second electric signal occurring by driving a second fluorescent lamp with the AC voltage; and an abnormality detection circuit that generates an abnormality detection signal corresponding to a difference between amplitudes of the first and the second detection signals. The inverter compares the abnormality detection signal with a predetermined threshold value to execute a circuit protecting operation in accordance with a comparison result.

When the lamp is normally driven, AC signals having substantially the same amplitude levels with each other are selected as the first and the second electric signals. Because the first and the second electric signals respectively have the same frequency ω as the AC voltage, S1(t)=A1×SIN(ωt) and S2(t)=A2×SIN(ωt) hold, where A1 and A2 respectively represent the amplitudes thereof. When the circuit is normally operated, A1=A2 holds, and hence a difference between the amplitudes A1−A2=0 holds. If an abnormality occurs in either one of the lamps, the difference ΔA occurs between the amplitude A1 of the first detection signal S1 and the amplitude A2 of the second detection signal S2, allowing the abnormality to be detected based on the difference ΔA between the amplitudes.

The first and the second detection signal generation units may generate the first and the second detection signals such that the two detection signals have phases opposite to each other, based on the electric signals having phases opposite to each other. In this case, the abnormality detection circuit may generate the abnormality detection signal based on a midpoint voltage of the first and the second detection signals. A time waveform of the midpoint voltage A12(t) is represented by A12(t)=(A1−A2)×SIN(ωt). When the amplitudes of the first and the second detection signals are equal to each other and have phases opposite to each other, the midpoint voltage thereof becomes 0V. When the difference ΔA occurs between the amplitudes A1 and A2, the amplitude of the midpoint voltage A12 becomes large. Accordingly, the difference ΔA between the amplitudes can be detected by monitoring the level of the midpoint voltage.

The first detection signal generation unit may generate the first detection signal in accordance with a current flowing in the first fluorescent lamp, while the second detection signal generation unit generate the second detection signal in accordance with a current flowing in the second fluorescent lamp. If an abnormality occurs in either one of the fluorescent lamps, the current flowing in the fluorescent lamp is varied to cause the difference between the amplitudes of the first and the second detection signals, allowing the abnormality to be detected.

The first detection signal generation unit may include a first detection resistor provided on a path of a first detection current corresponding to the current flowing in the first fluorescent lamp, so that a voltage drop across the first detection resistor is outputted as the first detection signal. The second detection signal generation unit may include a second detection resistor provided on a path of a second detection current corresponding to the current flowing in the second fluorescent lamp, so that a voltage drop across the second detection resistor is outputted as the second detection signal. The abnormality detection circuit may generate the abnormality detection signal based on the midpoint voltage of the first and the second detection signals.

The first detection signal generation unit may generate the first detection signal in accordance with a voltage occurring at one end of the first fluorescent lamp, while the second detection signal generation unit generate the second detection signal in accordance with a voltage occurring at one end of the second fluorescent lamp. If an abnormality occurs in either one of the fluorescent lamps, the voltage occurring at one end of the fluorescent lamp is varied to cause a difference between the amplitudes of the first and the second detection signals, allowing the abnormality to be detected.

The first detection signal generation unit may include a first pair of capacitors that divides the voltage occurring at one end of the first fluorescent lamp such that a divided voltage is outputted as the first detection signal. The second detection signal generation unit may include a second pair of capacitors that divides the voltage occurring at one end of the second fluorescent lamp such that a divided voltage is outputted as the second detection signal. The abnormality detection circuit may generate the abnormality detection signal based on the midpoint voltage of the first and the second detection signals.

The abnormality detection circuit may include: a first resistor, to a first terminal of which the first detection signal is applied; a second resistor, to a first terminal of which the second detection signal is applied; and a diode, an anode of which is connected to second terminals of the first resistor and the second resistor, both the second terminals being connected in common. The abnormality detection circuit may output a signal corresponding to a cathode voltage of the diode as the abnormality detection signal.

In this case, a midpoint voltage (average voltage) of the first detection signal and the second detection signal occurs at a connection point of the first resistor and the second resistor, the midpoint voltage being rectified by the diode. A difference between the amplitudes of the first and the second detection signals can be detected based on a rectified voltage occurring at the cathode of the diode.

The abnormality detection circuit may further include a filter that performs filtering on the cathode voltage. In this case, a DC signal corresponding to an amplitude of the midpoint voltage can be generated by rectifying and smoothing the midpoint voltage with the diode and the filter.

Another embodiment of the present invention also relates to a driving apparatus for a fluorescent lamp. The driving apparatus comprises: an inverter that supplies AC voltages having phases opposite to each other to either of the fluorescent lamp; a first detection signal generation unit that generates a first detection signal corresponding to an electric signal occurring at one end of the fluorescent lamp; a second detection signal generation unit that generates a second detection signal corresponding to an electric signal occurring at the other end of the fluorescent lamp; and an abnormality detection circuit that generates an abnormality detection signal corresponding to a difference between amplitudes of the first detection signal and the second detection signal. The inverter compares the abnormality detection signal with a predetermined threshold value to execute a circuit protecting operation in accordance with a comparison result.

According to the embodiment, if a fault such as disconnection or short circuit, etc., occurs in the fluorescent lamp, the difference between the amplitudes of the first detection signal and the second detection signal occurs, and hence the abnormality can be detected based on the difference between the amplitudes.

The first and the second detection signal generation units may generate the first and the second detection signals such that the two detection signals have phases opposite to each other. The abnormality detection circuit may generate the abnormality detection signal based on a midpoint voltage of the first and the second detection signals.

The first detection signal generation unit may monitor one end of the fluorescent lamp to generate the first detection signal based on a first detection current corresponding to a current flowing toward a first direction in the fluorescent lamp, while the second detection signal generation unit may monitor the other end of the fluorescent lamp to generate the second detection signal based on a second detection current corresponding to a current flowing toward a second direction in the fluorescent lamp.

The first detection signal generation unit may generate the first detection signal corresponding to a voltage at one end of the fluorescent lamp, while the second detection signal generation unit may generate the second detection signal based on a voltage at the other end of the fluorescent lamp.

The fluorescent lamp may have a U-shape. In this case, the inverters for applying voltages to both ends of the fluorescent lamp can be arranged on one side of the fluorescent lamp in a concentrated manner.

Yet another embodiment of the present invention relates to a light emitting apparatus. The light emitting apparatus comprises a plurality of fluorescent lamps and any one of the aforementioned driving apparatuses that drives the plurality of fluorescent lamps. The fluorescent lamp may be a CCFL.

Yet another embodiment of the present invention relates to an LCD TV. The LCD TV comprises an LCD panel and a plurality of the aforementioned light emitting apparatuses arranged on the back surface of the LCD panel.

Yet another embodiment of the present invention relates to a driving method for a plurality of fluorescent lamps. The driving method comprises: supplying an AC drive voltage to the plurality of fluorescent lamp; monitoring a first terminal where a first AC signal having a predetermined amplitude occurs when a first fluorescent lamp is normally lighted; monitoring a second terminal where a second AC signal having a predetermined amplitude occurs when a second fluorescent lamp is normally lighted; determining that an abnormality occurs when a difference between the amplitudes of the first AC signal and the second AC signal exceeds a predetermined threshold value; and executing a circuit protecting operation when determining that an abnormality has occurred. The first fluorescent lamp and the second fluorescent lamp may or may not be the same with each other.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram illustrating a structure of a light emitting apparatus according to a first embodiment;

FIG. 2 is a block diagram illustrating a structure of an LCD TV in which the light emitting apparatus according to the embodiment is installed;

FIGS. 3A to 3C are operational waveform diagrams of the light emitting apparatus in FIG. 1;

FIG. 4 is a circuit diagram illustrating a structure of a light emitting apparatus provided with n-pieces of CCFLs;

FIG. 5 is a circuit diagram illustrating a structure of a variation of the light emitting apparatus in FIG. 1; and

FIG. 6 is a circuit diagram illustrating a structure of a light emitting apparatus according to a second embodiment.

### DETAILED DESCRIPTION OF THE INVENTION

The present invention will now be described based on preferred embodiments with reference to the accompanying drawings. The same or equivalent constituents, member, or processes illustrated in each drawing will be denoted with the same reference numerals, and the duplicative descriptions thereof are appropriately omitted. The preferred embodiments do not intend to limit the scope of the invention but exemplify the invention. All of the features and the combinations thereof described in the embodiments are not necessarily essential to the invention.

Herein, “the state where a member A is connected to a member B” includes not only the state where the member A is physically and directly connected to the member B but also the state where the member A is indirectly connected to the member B via another member that does not affect electrically the connection state between them.

### First Embodiment

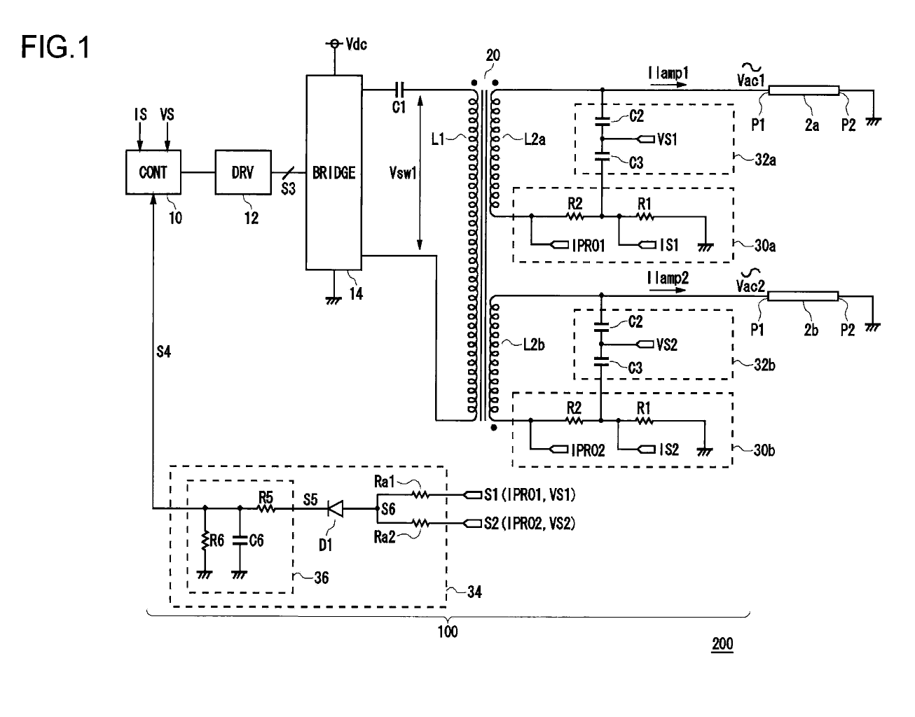

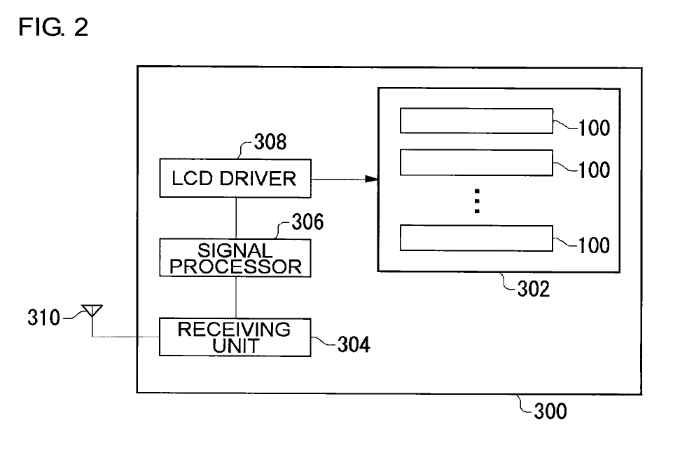

FIG. 1 is a circuit diagram illustrating a structure of a light emitting apparatus 200 according to a first embodiment of the present invention. FIG. 2 is a block diagram illustrating a structure of an LCD TV 300 in which the light emitting apparatus in FIG. 1 is installed. The LCD TV 300 is connected to an antenna 310. The antenna 310 receives a broadcast wave and outputs a received signal to a receiving unit 304. The receiving unit 304 detects and amplifies the received signal to output it to a signal processor 306. The signal processor 306 outputs image data obtained by demodulating modulated data to an LCD driver 308. The LCD driver 308 outputs the image data to an LCD panel 302 for every scanning line such that a screen image or a picture image is displayed. A plurality of light emitting apparatuses 200 are arranged on the back surface of the LCD panel 302 as backlights. The light emitting apparatus 200 according to the present embodiment can be preferably used as a backlight for such an LCD panel 302. Referring back to FIG. 1, the structure of the light emitting apparatus 200 will be described below.

The light emitting apparatus 200 according to the present embodiment includes a first CCFL 2a, a second CCFL 2b (hereinafter, collectively referred to as a CCFL 2) and a driving apparatus 100. The CCFL 2 is an I-shaped fluorescent lamp and is arranged on the back surface of the LCD panel 302.

The driving apparatus 100 includes an inverter such that a DC voltage Vdc is converted into an AC voltage to be boosted, and a first AC voltage Vac1 and a second AC voltage Vac2 having phases opposite to each other are supplied to first terminals P1 of the first CCFL 2a and the second CCFL 2b. Thereby, brightness of the CCFL 2 is feedback-controlled. Second terminals P2 of the first CCFL 2a and the second CCFL 2b are grounded.

The driving apparatus 100 comprises a control circuit 10, a driver 12, a bridge circuit 14, a capacitor C1, a transformer 20, a first current detection unit 30a, a first voltage detection unit 32a, a second current detection unit 30b, a second voltage detection unit 32b and an abnormality detection circuit 34.

The transformer 20 comprises a primary coil L1, a secondary coil L2a and a secondary coil L2b. The primary coil L1 and the secondary coil L2a are arranged in the same polarity to each other, while the secondary coil L2b is arranged in opposite polarity with respect to the primary coil L1. The primary coil L1 is connected to the bridge circuit 14 through the capacitor C1. The bridge circuit 14 is a half-bridge circuit or a full-bridge circuit, applying a switching voltage Vsw1 to both ends of the primary coil L1 based on a drive signal S3 outputted from the driver 12.

At both ends of the secondary coil L2a, the first AC voltage Vac1 occurs, which corresponds to a turns ratio of the secondary coil L2a to the primary coil L1. Likewise, at both ends of the secondary coil L2b, the second AC voltage Vac2 occurs, which corresponds to a turns ratio of the secondary coil L2b to the primary coil L1. Because the secondary coils L2a and L2b are arranged in opposite polarity, the first AC voltage Vac1 and the second AC voltage Vac2 have phases opposite to each other.

The first current detection unit 30a generates a current feedback signal IS1 and a current detection signal IPRO1, which correspond to a lamp current Ilamp1 occurring when the first CCFL 2a is driven by the AC voltage Vac1. The first current detection unit 30a includes resistors R1 and R2 provided on a path of the lamp current Ilamp1. The current feedback signal IS1 represents a voltage drop occurring when the lamp current Ilamp1 flows in the resistor R1. The current detection signal IPRO1 represents a voltage drop occurring when the lamp current Ilamp1 flows in the resistors R1 and R2. Likewise, the second current detection unit 30b is provided for the second CCFL 2b.

The first voltage detection unit 32a generates a first voltage detection signal VS1 corresponding to a voltage occurring at the first terminal P1 of the first CCFL 2a when the first CCFL 2a is driven by the AC voltage Vac1. The first voltage detection unit 32a includes a pair of capacitors C2 and C3. The pair of capacitors C2 and C3 divides the voltage Vac1 occurring at one end P1 of the first CCFL 2a to output it as the first voltage detection signal VS1. Likewise, the second voltage detection unit 32b is provided for the second CCFL 2b.

The control circuit 10 adjusts the AC voltages Vac1 and Vac2 by performing feedback based on at least one of the voltage detection signals VS1 and VS2 (collectively referred to as VS), which are generated by the voltage detection unit 32, and the current feedback signals IS1 and IS2 (collectively referred to as IS), which are generated by the current detection unit 30. For example, prior to lighting of the CCFL 2, the control circuit 10 controls the AC voltage Vac based on the voltage detection signal VS to boost the AC voltage Vac to a level where the CCFL 2 can be lighted. After the CCFL 2 is lighted, the control circuit 10 adjusts the AC voltage Vac based on the current feedback signal IS such that the lamp current Ilamp flowing in the CCFL 2 is maintained at a certain value to stabilize the brightness thereof.

Known various techniques can be used for the feedback control by the control circuit 10, without limiting to that of the aforementioned embodiments. In addition, topologies for the transformer 20 and the bridge circuit 14, which are used for driving the plurality of CCFLs 2, should not be limited to that in FIG. 1.

Generally and abstractly speaking, the abnormality detection circuit 34 executes the following processing. That is, the abnormality detection circuit 34 receives a first detection signal S1 corresponding to an electric signal occurring when the first CCFL 2a is driven by the first AC voltage Vac1, and a second detection signal S2 corresponding to an electric signal occurring when the second CCFL 2b is driven by the second AC voltage Vac2. The first detection signal S1 and the second detection signal S2 are signals corresponding to the same electric quantities (currents, voltages or electric powers) to each other, and when the first CCFL 2a and the second CCFL 2b are normally driven, the signals S1 and S2 have substantially the same amplitudes to each other. The “same electric quantities” means ones occurring at places corresponding to each other in different fluorescent lamps. It is assumed that S1(t)=A1×SIN(ωt) and S2(t)=A2×SIN(ωt) hold, where A1 and A2 are, respectively, the amplitudes of the first detection signal S1 and the second detection signal S2. The abnormality detection circuit 34 outputs an abnormality detection signal S4 corresponding to a difference ΔA (=A1−A2) between the amplitude A1 of the first detection signal S1 and the amplitude A2 of the second detection signal S2.

The control circuit 10 receives the abnormality detection signal S4, and compares it with a predetermined threshold value to execute a predetermined circuit protecting operation in accordance with a comparison result. The circuit protecting operations include, for example, a drive-stop operation of the CCFL 2 and an operation of lowering the AC voltage Vac.

According to the aforementioned embodiment, because the amplitudes of the first and the second detection signals S1 and S2 are approximately equal to each other when the first CCFL 2a and the second CCFL 2b are normally driven, the difference ΔA between the amplitudes becomes smaller than the threshold value. If either one of the CCFL 2 undergoes a circuit abnormality such as disconnection, short circuit, arc discharge or the like, the amplitudes A1 and A2 of the first and the second detection signals S1 and S2 are not equal to each other, and hence the difference ΔA between the amplitudes thereof is increased, exceeding the threshold value Sth. Accordingly, a circuit abnormality can be preferably detected by comparing the difference ΔA between the amplitudes with the threshold value Sth. The threshold value Sth can be set based on the difference ΔA between the amplitudes A1 and A2 of the first and the second detection signals S1 and S2 when a circuit abnormality occurs.

Specifically, the abnormality detection circuit 34 executes either one of the following processing 1 and 2, or combination thereof.

### 1. Abnormality Detection by Current Detection

In the first processing, it is assumed that the first detection signal S1 is a signal corresponding to the lamp current Ilamp1 flowing in the first CCFL 2a, while the second detection signal S2 is a signal corresponding to the lamp current Ilamp2 flowing in the second CCFL 2b. In this case, a first current detection signal IPRO1 generated by the first current detection unit 30a has to be used as the first detection signal S1, and a second current detection signal IPRO2 generated by the second current detection unit 30b has to be used as the second detection signal S2.

The abnormality detection circuit 34 outputs a difference ΔA between the amplitude A1 of the first current detection signal IPRO1 and the amplitude A2 of the second current detection signal IPRO2 as the abnormality detection signal S4. Because the first CCFL 2a and the second CCFL 2b are driven in phases opposite to each other, the lamp currents Ilamp1 and Ilamp2 respectively flowing therein have AC waveforms with phases opposite to each other. That is, because the first and the second current detection signals IPRO1 and IPRO2 are AC signals having phases opposite to each other, the abnormality detection circuit 34 in FIG. 1 generates a signal S5 corresponding to the difference ΔA between the amplitudes, by adding together or averaging the two AC signals:

S5=(A1−A2)×SIN(ωt)=ΔA×SIN(ωt)

The abnormality detection circuit 34 includes a first resistor Ra1, a second resistor Ra2, a diode D1 and a filter 36. The first detection signal S1 is applied to a first terminal of the first resistor Ra1. The second detection signal S2 is applied to a first terminal of the second resistor Ra2. Second terminals of the first resistor Ra1 and the second resistor Ra2 are connected together. The anode of the diode D1 is connected to the second terminals of the two resistors. When resistance values of the resistors Ra1 and Ra2 are equal to each other, an anode voltage S6 is represented by the following equation:

S6=(A1−A2)/2×SIN(ωt)=ΔA/2×SIN(ωt).

The voltage S6 becomes a midpoint voltage of the first and the second detection signals S1 and S2.

When the first and the second detection signals S1 and S2 have phases opposite to each other and the amplitudes thereof are equal to each other, the midpoint voltage S6 becomes 0V. If the amplitudes or phases thereof are varied from each other due to a circuit abnormality, the midpoint voltage S6 becomes an AC signal having a certain amplitude. A voltage obtained by rectifying the midpoint voltage S6 is outputted to the cathode of the diode D1.

The filter 36 includes a resistor R5 and a capacitor R6, and performs filtering on the cathode voltage S5 of the diode D1 to output it as the abnormality detection signal S4. A resistor R6 is provided to pull down the abnormality detection signal S4. The abnormality detection signal S4 becomes normally low by the resistor R6.

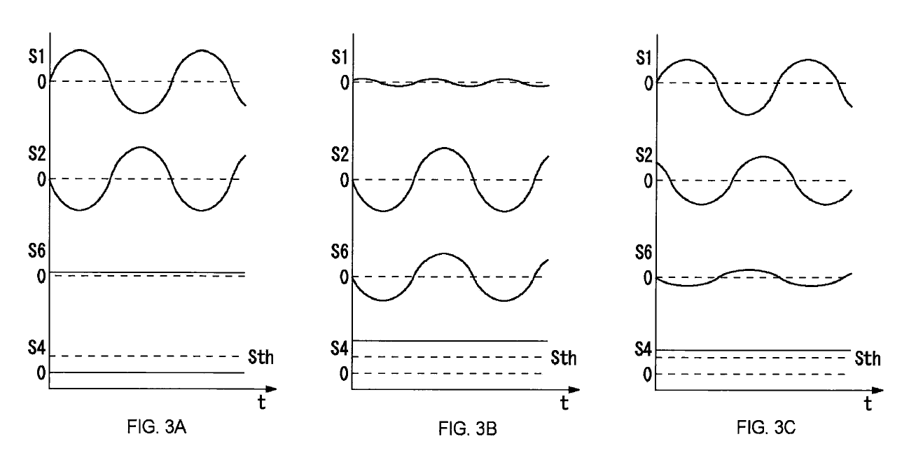

Operation of the light emitting apparatus 200 thus structured will be described below. FIGS. 3A to 3C are operational waveform diagrams of the light emitting apparatus 200 in FIG. 1. FIG. 3A illustrates operation while normally operating, FIG. 3B illustrates that while a lamp is being disconnected and FIG. 3C illustrates that while arc discharge is occurring. The vertical axis and the horizontal axis of each waveform diagram are appropriately enlarged or reduced for easier understanding, and each illustrated waveform is also simplified for the sake of facilitating the understanding.

As illustrated in FIG. 3A, while normally operating, the amplitudes A1 and A2 of the first and the second detection signals S1 and S2 are equal to each other. Accordingly, the midpoint voltage S6 thereof becomes 0V, and the abnormality detection signal S4 also becomes 0V. The control circuit 10 receives the abnormality detection signal S4 and compares it with the threshold value Sth. As a result, because a level of the abnormality detection signal S4 is smaller than the threshold value Sth, the control circuit 10 continues a usual drive.

As illustrated in FIG. 3B, when the first CCFL 2a, one of the CCFLs 2, is disconnected, the amplitude A1 of the first detection signal S1 becomes small. As a result, the midpoint voltage S6 becomes an AC signal having an amplitude corresponding to the difference ΔA between the amplitudes A1 and A2. The midpoint voltage S6 is rectified by the diode D1 and then smoothed through the filter 36 such that a DC abnormality detection signal S4 is generated. In the case, because a voltage level of the abnormality detection signal S4 is larger than the threshold value Sth, the control circuit 10 executes the predetermined circuit protecting operation.

As illustrated in FIG. 3C, when the first CCFL 2a undergoes arc discharge, the voltage level of the abnormality detection signal S4 is also larger than the threshold value Sth. Accordingly, the control circuit 10 executes the predetermined circuit protecting operation. Because the abnormality detection circuit 34 in FIG. 1 averages (adds together) the first detection signal S1 and the second detection signal S2, the midpoint voltage S6 becomes an AC signal having an amplitude, even when a phase difference between the first and the second detection signals S1 and S2 is varied from the opposite phase (180°). Accordingly, an abnormality can be detected.

As stated above, a circuit can be protected from disconnection or arc discharge according to the light emitting apparatus 200 in FIG. 1.

### 2. Abnormality Detection by Voltage Detection

An abnormality may be detected by voltage detection, instead of the aforementioned current detection. That is, the abnormality detection circuit 34 may receive, as the first detection signal S1, a first voltage detection signal VS1 corresponding to the first AC voltage Vac1 occurring at the first terminal P1 of the first CCFL 2a, while may receive, as the second detection signal S2, a second voltage detection signal VS2 corresponding to the second AC voltage Vac2 occurring at the first terminal P1 of the second CCFL 2b.

In this case, when an abnormality occurs in the first CCFL 2a or the second CCFL 2b, the midpoint voltage S6 of the first and the second detection signals S1 and S2 becomes an AC signal having an amplitude. Accordingly, the circuit protecting operation can be executed in the same way as the case of current detection.

The light emitting apparatus 200 in FIG. 1 has been described with respect to its circuit that drives the two CCFLs 2. Subsequently, a technique in which the circuit protecting technique according to the present embodiment is applied to many CCFLs 2, will be described.

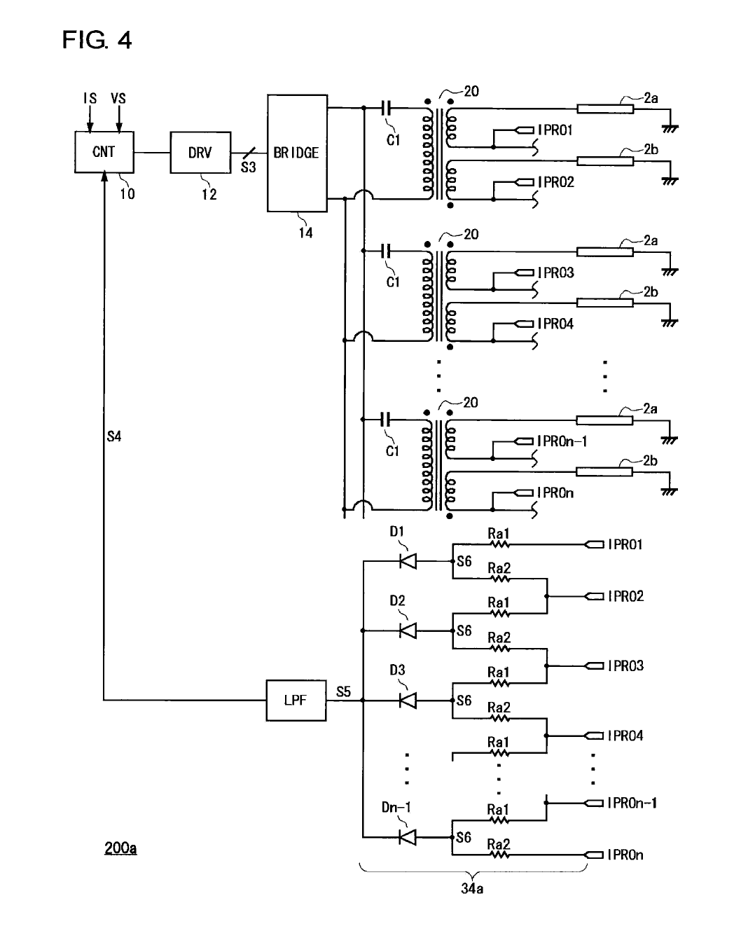

FIG. 4 is a circuit diagram illustrating a structure of a light emitting apparatus 200a provided with n-pieces of the CCFLs 2. The light emitting apparatus 200a comprises a plurality of transformers 20 to which a switching voltage Vsw1 is supplied by a common bridge circuit 14. Each of the transformers 20 is connected to the CCFLs 2a and 2b in the same way as in FIG. 1. In the following circuit diagrams, the current detection unit 30 and the voltage detection unit 32 will be appropriately omitted.

In the light emitting apparatus 200a in FIG. 4, the current detection signals IPRO1 to IPROn for each CCFL 2 are inputted to an abnormal detection circuit 34a. The voltage detection signals VS may be used instead of the current detection signals IPRO.

The abnormality detection circuit 34 comprises a plurality of diodes D1 to Dn−1. The i-th diode D1 is provided for every group of the i-th and the i+1-th current detection signals IPROi and IPROi+1, which are consecutive to each other. The adjacent current detection signals have phases opposite to each other. Cathodes of the plurality of diodes D1 to Dn−1 are connected together in common such that the cathode voltage S5 is outputted through the filter 36.

The i-th current detection signal IPROi is inputted to the anode of the i-th diode D1 through a resistor Ra1, and the i+1-th current detection signal IPROi+1 is inputted thereto through a resistor Ra2. When a difference occurs between the amplitudes of the current detection signals IPROi and IPROi+1, which are inputted to the diode Di in common, the midpoint voltage S6 occurring at the anode of the diode Di is increased. As a result, a level of the abnormality detection signal S4 is also increased, allowing the circuit protecting operation to be executed by the control circuit 10.

According to the light emitting apparatus 200a in FIG. 4, if an abnormality occurs in any one of the CCFLs 2, the abnormality detection signal S4 exceeds the threshold value Sth, allowing the circuit protecting operation to be executed.

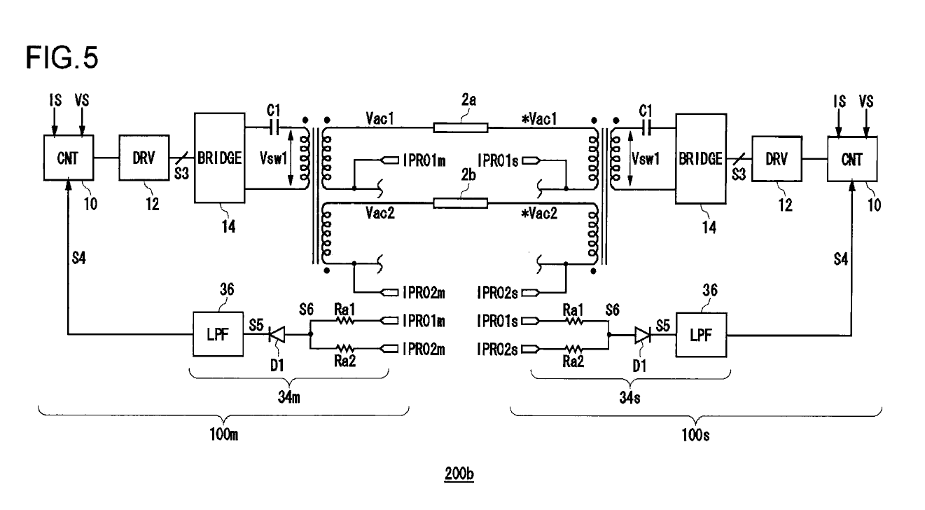

FIG. 5 is a circuit diagram illustrating a structure of a variation of the light emitting apparatus in FIG. 1. In the light emitting apparatus 200 in FIG. 1, the AC voltage Va is supplied to one end of the I-shaped CCFL. In a light emitting apparatus 200b in FIG. 5, AC voltages Vac having phases opposite to each other are supplied to both ends of the I-shaped CCFL. The light emitting apparatus 200b comprises two driving apparatuses 100m and 100s. The driving apparatus 100m in a master channel supplies AC voltages Vac1 and Vac2 to each one end of the first CCFL 2a and the second CCFL 2b, the AC voltages Vac1 and Vac2 having phases opposite to each other. The driving apparatus 100s in a slave channel supplies output voltages *Vac1 and *Vac2 to the other ends of the first CCFL 2a and the second CCFL 2b. The voltages Vac1 and *Vac1 have phases opposite to each other, and the voltages Vac2 and *Vac2 also have phases opposite to each other.

An abnormality detection circuit 34m in the master channel generates the abnormality detection signal S4 based on a first current detection signal IPRO1m and a second current detection signal IPRO2m in the master channel. When the abnormality detection signal S4 exceeds the threshold value Sth, the control circuit 10 in the master channel executes the circuit protecting operation. Similar processing is executed on the side of the slave channel.

Also in the light emitting apparatus 200b in FIG. 5, when an abnormality or a fault occurs in any one of CCFLs 2, the abnormality or the fault can be surely detected. The light emitting apparatus 200b in FIG. 5 can also be used for driving still more CCFLs 2 as illustrated in FIG. 4.

### Second Embodiment

In the first embodiment, signals occurring at places in different CCFLs 2, the places corresponding to each other, are used as the first and the second detection signals S1 and S2. In the second embodiment, the case where signals occurring in the same CCFL 2 are used as the first and the second detection signals S1 and S2, will be described.

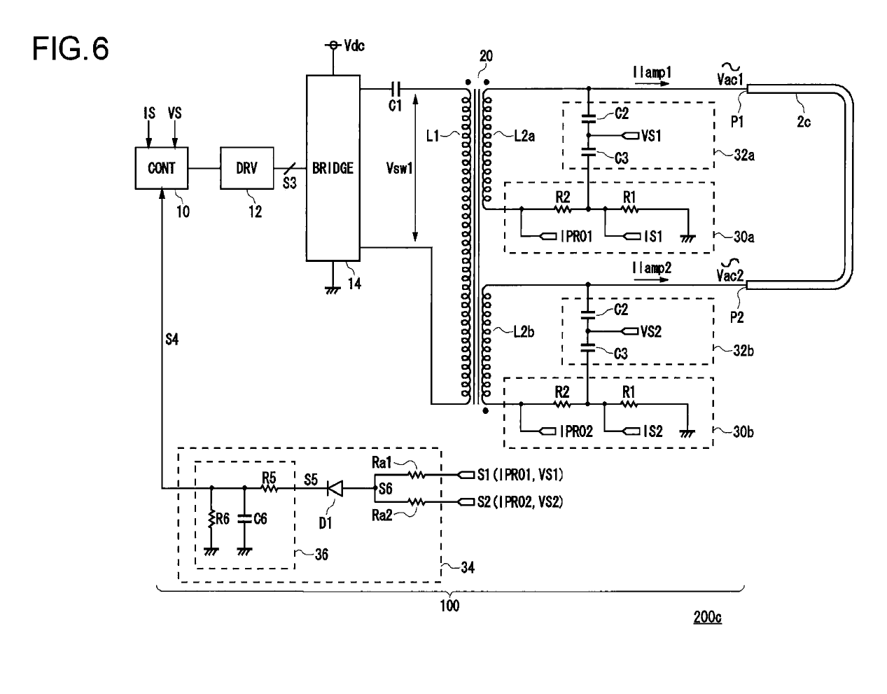

FIG. 6 is a circuit diagram illustrating a structure of a light emitting apparatus 200c according to the second embodiment. The light emitting apparatus 200c in FIG. 6 has a structure in which the first CCFL 2a and the second CCFL 2b in the light emitting apparatus 200 in FIG. 1 are replaced by a U-shaped CCFL 2c. That is, the first AC voltage Vac1 is applied to a first terminal P1 of the U-shaped CCFL 3 and the second AC voltage Vac2 having an opposite phase is applied to a second terminal P2 thereof.

The abnormality detection circuit 34 executes an abnormality detecting operation based on amplitudes of AC signals (currents or voltages) across both ends of the CCFL 2c, the AC signals having phases opposite to each other. That is, the current detection signals IPRO1 and IPRO2 may be used, or the voltage detection signals VS1 and VS2 may be used, as the first and the second detection signals S1 and S2. Alternatively, the second terminals of the first CCFL 2a and the second CCFL 2b in FIG. 1 may be connected together instead of the U-shaped CCFL 2c.

In the case, because both ends of the single CCFL 2c are monitored, an abnormality can be detected in a more diversified or a surer way than the circuit in FIG. 1.

When abstracting the circuit protecting method described in first and second embodiments from another point of view, the following technical thought can be obtained. That is, the driving method executes the following processing (1) to (5):

(1) an AC drive voltage is supplied to a plurality of fluorescent lamps;

(2) a first terminal is monitored where an AC signal having a predetermined amplitude occurs when a first fluorescent lamp is normally lighted;

(3) a second terminal is monitored where a second AC signal having a predetermined amplitude that is substantially the same as the first AC signal, occurs when a second fluorescent lamp is normally lighted, wherein the first and the second fluorescent lamps may be the same with each other;

(4) it is determined that a circuit abnormality has occurred when a difference between the amplitudes of the first and the second AC signals exceeds a predetermined threshold value; and

(5) a circuit protecting operation is executed when it is determined that a circuit abnormality has occurred.

According to the technical thought, when a circuit abnormality occurs, a difference between amplitudes of two AC signals is caused, allowing a circuit protecting operation to be executed in accordance with the difference between the amplitudes.

The embodiments are intended to be illustrative only. It will be appreciated by those skilled in the art that various modifications to the constituting elements and processes could be developed and that such modifications are within the scope of the present invention. Some modifications will be exemplified below.

In the preferred embodiments, the first and the second detection signals S1 and S2 are generated such that they have phases opposite to each other, and with this, the difference ΔA between the amplitudes of the first and the second detection signals S1 and S2 is generated with the midpoint voltage S6. In order to generate the midpoint voltage S6, voltage division by the resistors Ra1 and Rat is used; however, an adder including an operational amplifier may be used.

In addition, the first and the second detection signals S1 and S2 may be common-mode signals having the substantially same amplitudes to each other while normally operating. In this case, a subtractor may be used in order to generate a differential signal between the first and the second detection signals S1 and S2.

In the preferred embodiments, the differential signal (S6) between the first and the second detection signals S1 and S2 is generated such that an amplitude thereof is detected. As a modification thereof, each of the first and the second detection signals S1 and S2 may be rectified and smoothed to generate a first and a second DC signals, which correspond to amplitudes thereof, so that the abnormality detection signal S4 corresponding to a difference ΔA between the amplitudes of the first and the second DC signals, is generated based on the difference between the two DC signals.

While the preferred embodiments of the present invention have been described using specific terms, such description is for illustrative purposes only, and it is to be understood that changes and variations may be made without departing from the spirit or scope of the appended claims.

1. A driving apparatus that drives a plurality of fluorescent lamps, the driving apparatus comprising:
an inverter that supplies an AC voltage to the plurality of fluorescent lamps to be driven;
a first detection signal generation unit that generates a first detection signal corresponding to a first electric signal occurring by driving a first fluorescent lamp with the AC voltage;
a second detection signal generation unit that generates a second detection signal corresponding to a second electric signal occurring by driving a second fluorescent lamp with the AC voltage; and
an abnormality detection circuit that generates an abnormality detection signal corresponding to a difference between amplitudes of the first and the second detection signals, wherein the inverter compares the abnormality detection signal with a predetermined threshold value to execute a circuit protecting operation in accordance with a comparison result.

2. The driving apparatus according to claim 1, wherein the first and the second detection signal generation units generate the first and the second detection signals such that the two detection signals have phases opposite to each other, based on the electric signals having phases opposite to each other, and wherein the abnormality detection circuit generates the abnormality detection signal based on a midpoint voltage of the first and the second detection signals.

3. The driving apparatus according to claim 1, wherein the first detection signal generation unit generates the first detection signal in accordance with a current flowing in the first fluorescent lamp, and wherein the second detection signal generation unit generates the second detection signal in accordance with a current flowing in the second fluorescent lamp.

4. The driving apparatus according to claim 3, wherein the first detection signal generation unit includes a first detection resistor provided on a path of a first detection current corresponding to the current flowing in the first fluorescent lamp, so that a voltage drop across the first detection resistor is outputted as the first detection signal, and wherein the second detection signal generation unit includes a second detection resistor provided on a path of a second detection current corresponding to the current flowing in the second fluorescent lamp, so that a voltage drop across the second detection resistor is outputted as the second detection signal, and wherein the abnormality detection circuit generates the abnormality detection signal based on the midpoint voltage of the first and the second detection signals.

5. The driving apparatus according to claim 1, wherein the first detection signal generation unit generates the first detection signal in accordance with a voltage occurring at one end of the first fluorescent lamp, and wherein the second detection signal generation unit generates the second detection signal in accordance with a voltage occurring at one end of the second fluorescent lamp.

6. The driving apparatus according to claim 5, wherein the first detection signal generation unit includes a first pair of capacitors that divides the voltage occurring at one end of the first fluorescent lamp such that a divided voltage is outputted as the first detection signal, and wherein the second detection signal generation unit includes a second pair of capacitors that divides the voltage occurring at one end of the second fluorescent lamp such that a divided voltage is outputted as the second detection signal, and wherein the abnormality detection circuit generates the abnormality detection signal based on the midpoint voltage of the first and the second detection signals.

7. The driving apparatus according to claim 4, wherein the abnormality detection circuit includes:
a first resistor, to a first terminal of which the first detection signal is applied;
a second resistor, to a first terminal of which the second detection signal is applied; and
a diode, an anode of which is connected to second terminals of the first resistor and the second resistor, both the second terminals being connected in common, and wherein
the abnormality detection circuit outputs a signal corresponding to a cathode voltage of the diode as the abnormality detection signal.

8. The driving apparatus according to claim 7, wherein the abnormality detection circuit further includes a filter that performs filtering on the cathode voltage.

9. A driving apparatus for a fluorescent lamp, comprising:
an inverter that supplies AC voltages having phases opposite to each other to either of the fluorescent lamp;
a first detection signal generation unit that generates a first detection signal corresponding to an electric signal occurring at one end of the fluorescent lamp;
a second detection signal generation unit that generates a second detection signal corresponding to an electric signal occurring at the other end of the fluorescent lamp; and
an abnormality detection circuit that generates an abnormality detection signal corresponding to a difference between amplitudes of the first detection signal and the second detection signal, wherein the inverter compares the abnormality detection signal with a predetermined threshold value to execute a circuit protecting operation in accordance with a comparison result.

10. The driving apparatus according to claim 9, wherein the first and the second detection signal generation units generate the first and the second detection signals such that the two detection signals have phases opposite to each other, and wherein the abnormality detection circuit generates the abnormality detection signal based on a midpoint voltage of the first and the second detection signals.

11. The driving apparatus according to claim 10, wherein the first detection signal generation unit monitors one end of the fluorescent lamp to generate the first detection signal based on a first detection current corresponding to a current flowing toward a first direction in the fluorescent lamp, and wherein the second detection signal generation unit monitors the other end of the fluorescent lamp to generate the second detection signal based on a second detection current corresponding to a current flowing toward a second direction in the fluorescent lamp.

12. The driving apparatus according to claim 11, wherein the first detection signal generation unit includes a first detection resistor provided on a path of the first detection current and provided on one end side of the fluorescent lamp, so that a voltage drop across the first detection resistor is outputted as the first detection signal, and wherein the second detection signal generation unit includes a second detection resistor provided on a path of the second detection current and provided on the other end side of the fluorescent lamp, so that a voltage drop across the second detection resistor is outputted as the second detection signal.

13. The driving apparatus according to claim 10, wherein the first detection signal generation unit generates the first detection signal corresponding to a voltage occurring at one end of the first fluorescent lamp, and wherein the second detection signal generation unit generates the second detection signal corresponding to a voltage occurring at the other end of the second fluorescent lamp.

14. The driving apparatus according to claim 13, wherein the first detection signal generation unit includes a first pair of capacitors that divides the voltage occurring at one end of the fluorescent lamp such that a divided voltage is outputted as the first detection signal, and wherein the second detection signal generation unit includes a second pair of capacitors that divides the voltage occurring at the other end of the fluorescent lamp such that a divided voltage is outputted as the second detection signal.

15. The driving apparatus according to claim 10, wherein the abnormality detection circuit includes:
a first resistor, to a first terminal of which the first detection signal is applied;
a second resistor, to a first terminal of which the second detection signal is applied; and
a diode, an anode of which is connected to second terminals of the first resistor and the second resistor, both the second terminals being connected in common, wherein
the abnormality detection circuit outputs a cathode voltage of the diode as the abnormality detection signal.

16. The driving apparatus according to claim 15, wherein the abnormality detection circuit further includes a filter that performs filtering on the cathode voltage.

17. The driving apparatus according to claim 9, wherein the fluorescent lamp has a U-shape.

18. A light emitting apparatus comprising:
a plurality of fluorescent lamps; and
any one of the driving apparatuses according to claim 1 that drives the plurality of fluorescent lamps.

19. The light emitting apparatus according to claim 18, wherein the fluorescent lamp is a cold cathode fluorescent lamp.

20. A liquid crystal display TV comprising:
a liquid crystal display panel; and
a plurality of the light emitting apparatuses according to claim 18 arranged on the back surface of the liquid crystal display panel.

21. A driving method for a plurality of fluorescent lamps, comprising:
supplying an AC drive voltage to the plurality of fluorescent lamps;
monitoring a first terminal where a first AC signal having a predetermined amplitude occurs when a first fluorescent lamp is normally lighted;
monitoring a second terminal where a second AC signal having a predetermined amplitude occurs when a second fluorescent lamp is normally lighted;
determining that an abnormality occurs when a difference between the amplitudes of the first AC signal and the second AC signal exceeds a predetermined threshold value; and
executing a circuit protecting operation when determining that an abnormality has occurred.
